(19) United States
(12) Patent Application Publication
(10) Pub. No.: US 2010/0113050 A1
(43) Pub. Date: May 6, 2010

(54) CARRIER AGGREGATION FOR OPTIMIZING SPECTRUM UTILIZATION

(76) Inventors: Fang-Chen Cheng, Randolph, NJ (US); Said Tatesh, Wiltshike (GB); Jung A. Lee, Pittstown, NJ (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 12/611,170

(22) Filed: Nov. 3, 2009

Related U.S. Application Data
(60) Provisional application No. 61/198,121, filed on Nov. 3, 2008.

(51) Int. Cl. H04W 72/04

(52) U.S. Cl. 455/450

(57) ABSTRACT

An exemplary method of allocating bandwidth to a call for at least one user includes allocating 10 MHz of the bandwidth for a downlink between a base station and the at least one user. 5 MHz of the bandwidth are allocated for an uplink between the user and the base station. A selected amount of bandwidth is aggregated to the allocated 5 MHz for the uplink. The amount of bandwidth that is aggregated is at least one of an additional 3 MHz band or two additional 1.4 MHz bands.

### CROSS REFERENCE TO RELATED APPLICATIONS

This application claims priority to U.S. Provisional Application No. 61/198,121 which was filed on Nov. 3, 2008.

### FIELD OF THE INVENTION

This invention generally relates to communication. More particularly, this invention relates to wireless communication.

### DESCRIPTION OF THE RELATED ART

Wireless communication systems are well known and in widespread use. A variety of system configurations are known. With such systems there are various challenges associated with providing wireless communication service to a variety of users.

For example, it is necessary to avoid interference among different users and different communication links. In the current LTE specification, for example, there is a guard band provided for out-of-band emission control. In some scenarios, the designed guard band is not sufficient. For example, some scenarios include uplink and downlink co-existence in a specific carrier band. The guard band is usually specified as a fixed spectrum block and is intended to address co-existence between mobile stations or co-existence between base stations. Adjacent uplink and downlink co-existence typically requires a larger guard band and an associated spurious emission because the downlink transmission power from a base station is normally much higher than that from the mobile station on the uplink. Even with known guard band approaches, there are scenarios in which improvements are required.

### SUMMARY

An exemplary method of allocating bandwidth to a call for at least one network includes allocating 10 MHz of the bandwidth for a downlink between a base station and at least one user. 5 MHz of the bandwidth is allocated for an uplink between the at least one user and the base station. A selected amount of bandwidth is aggregated to the allocated 5 MHz for the uplink. The amount of bandwidth that is aggregated is at least one of an additional 3 MHz band or two additional 1.4 MHz bands.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 schematically shows selected portions of an example communication system.

FIG. 2 is a flowchart diagram summarizing one example approach.

FIG. 3 schematically illustrates an example frequency band.

FIG. 4 schematically illustrates an example bandwidth allocation technique.

FIG. 5 schematically illustrates another example bandwidth allocation technique.

### DETAILED DESCRIPTION

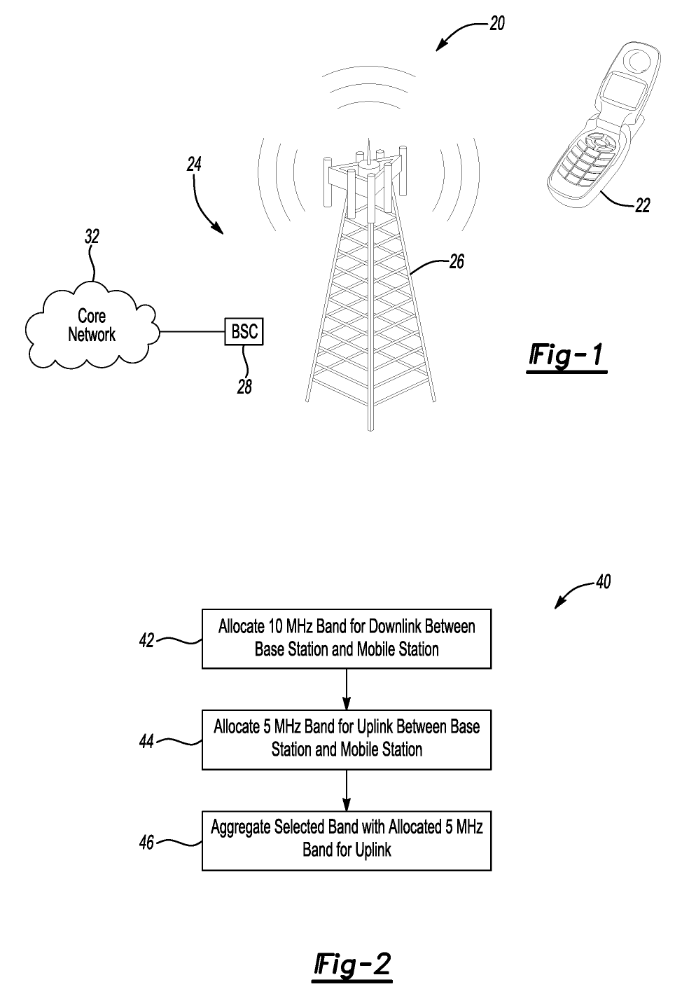

FIG. 1 schematically shows selected portions of a wireless communication system 20. A user can utilize a mobile station 22 for a variety of wireless communication features. A base station 24 including a cell tower 26 and base station controller (BSC) 28 communicates with the mobile station 22 over a downlink and an associated uplink. The base station 24 in the example of FIG. 1 is associated in a known manner with a core network 32, which includes known devices for facilitating communications between a mobile station 22 and another device.

One feature of the illustrated example is that it utilizes a carrier aggregation technique for optimizing the utilization of a frequency spectrum to facilitate co-existence with strong interference from a neighboring downlink public safety band transmission. A particular example that is useful with the LTE specification is described below. The carrier aggregation technique optimizes spectrum utilization and uplink system performance.

FIG. 2 includes a flowchart diagram 40 that summarizes one example approach for allocating bandwidth to a user of the mobile device 22, for example. At 42, a 10 MHz band is allocated for the downlink between the base station 24 and the mobile station 22. A 5 MHz band is allocated for an uplink between the base station 24 and the mobile station 22. This is shown at 44 in FIG. 2. At 46, a selected band is aggregated with the allocated 5 MHz band for the uplink. The allocated 5 MHz and the aggregated band are managed as a unit and they are associated with the 10 MHz band allocated for the downlink.

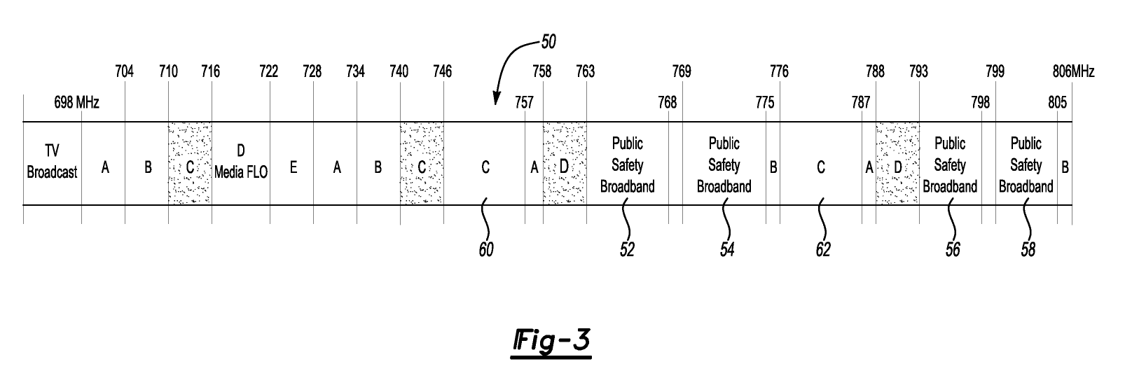

FIG. 3 schematically shows a frequency spectrum 50 that includes the 700 MHz spectrum (i.e., between 700 MHz and 800 MHz). The frequency spectrum 50 is segmented with some portions being dedicated to particular use. For example, a band 52 between 763 MHz and 768 MHz is dedicated to public safety broadband downlink transmissions. A band 54 between 769 MHz and 775 MHz is dedicated to public safety narrow band downlink transmissions. Another band 56 between 793 MHz and 798 MHz is dedicated to public safety broadband uplink transmissions. Another band 58 between 799 MHz and 805 MHz is dedicated to public safety narrow band uplink transmissions.

In the example of FIG. 3, a band 60 between 746 MHz and 757 MHz can be used for downlink traffic between the base station 24 and the mobile station 22. A band 62 between 776 MHz and 787 MHz can be used for uplink transmissions between the mobile station 22 and the base station 24.

One challenge associated with using the band 62 for such uplink transmissions is that the band 62 is adjacent the band 54. The closeness of those two bands requires special accommodations to ensure an appropriate out-of-band emission control to deal with interference from downlink transmissions on the public safety band 54.

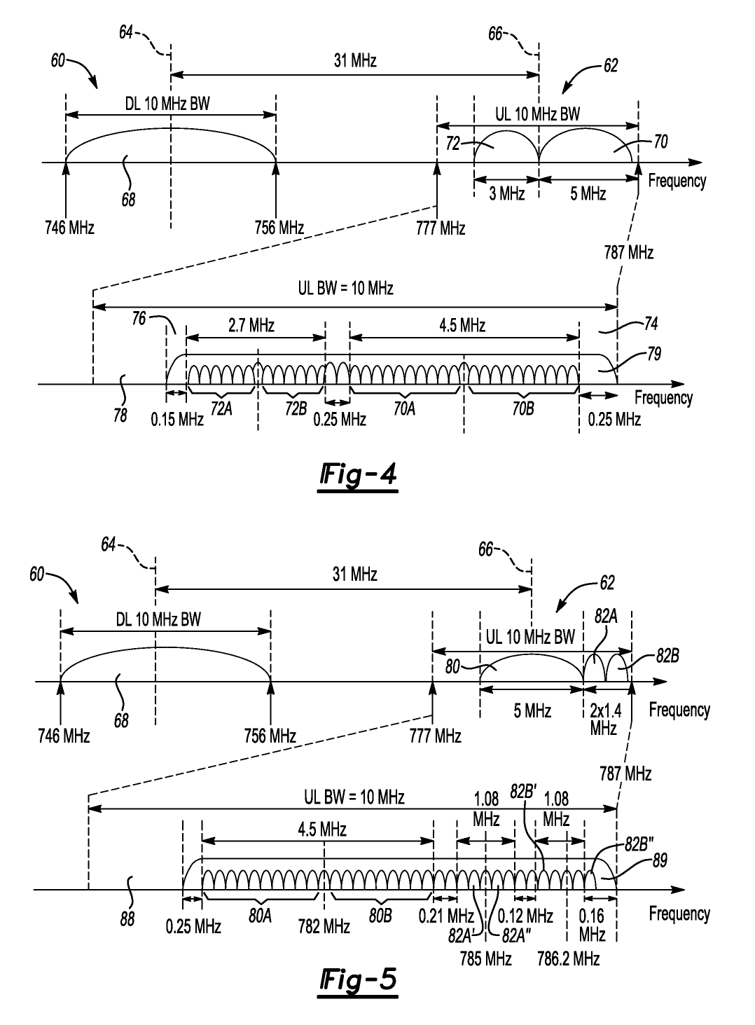

One example technique for allocating bandwidth for the uplink between the mobile station 22 and the base station 24 is schematically shown in FIG. 4. The band 60 in this example is between 746 MHz and 756 MHz and the band 62 is between 777 MHz and 787 MHz. There is a 31 MHz separation between the center 64 of the downlink band 60 and the center 66 of the uplink band 62.

In this example, the entire 10 MHz bandwidth at 68 is allocated to the downlink between the base station 24 and the mobile station 22. 5 MHz shown at 70 is allocated to the uplink communications between the mobile station 22 and the base station 24. In this example, the 5 MHz allocated to the uplink as shown at 70 is in the upper portion of the band 62. In the illustrated example, the allocated 5 MHz is between 782 MHz and 787 MHz. Allocating the 5 MHz shown at 70 to the uplink allows the system to operate with sufficient guard band to reject interference from the neighboring public safety band downlink transmissions in the band 54 of FIG. 3.

There is additional unused uplink spectrum within the band 62. In the example of FIG. 4, a selected amount of that bandwidth is aggregated to the allocated 5 MHz for the uplink. In this example, an additional 3 MHz band 72 is aggregated to the 5 MHz 70 for the uplink. According to the LTE R-8 specification, bandwidth allocations can be in the amount of 20 MHz, 15 MHz, 10 MHz, 5 MHz, 3 MHz or 1.4 MHz. The allocated and aggregated bandwidth 70 and 72 in this example utilizes bandwidth allocation amounts according to the specification. Therefore, this example can be utilized without requiring any change to this standard.

The example of FIG. 4 includes utilizing 4.5 MHz of the allocated 5 MHz 70 for the uplink traffic. As schematically shown in FIG. 4, the portions 70A and 70B of the allocated 5 MHz band are utilized for traffic. This leaves an additional 0.25 MHz on either side of those portions. A similar technique is implemented for the 3 MHz band 72 such that 2.7 MHz is utilized for the uplink traffic as shown at 72A and 72B. This particular configuration provides guard band portions at 74 (in the amount of 0.25 MHz), 76 (in the amount of 0.15 MHz) and 78 (in the amount of 2 MHz). The technique of FIG. 4, therefore, provides for additional guard band at each end of the allocated bandwidth actually utilized for uplink traffic. In this example, 0.25 MHz guard band is provided at 74 on one side of the allocated uplink band width and a 2.15 MHz guard band is provided on an opposite side at 78.

The allocated 5 MHz 70 and the aggregated band 72 are managed as a unity and associated together with the resource of the allocated 10 MHz for the downlink.

Another carrier allocation and aggregation technique is shown in FIG. 5. In this example, a 5 MHz band 80 is allocated to the uplink traffic. The allocated 5 MHz band 80 in this case is centered within the 10 MHz band 62. This leaves 2.5 MHz on each side of the 5 MHz band 80. Two 1.4 MHz bands 82A and 82B are aggregated to the 5 MHz band 80 and allocated for the uplink traffic. This is another example that utilizes acceptable band sizes for the LTE specification.

As schematically shown in FIG. 5, not all of the allocated bandwidth is utilized for the uplink traffic. 4.5 MHz of the 5 MHz band 80 is actually utilized for uplink traffic leaving additional guard band frequency. The portions shown at 80A and 80B are utilized for the uplink traffic leaving 0.25 MHz on either side of those portions. The 1.4 MHz bands are also segmented and only a portion at 82A′, 82A″, 82B′ and 82B″ are actually utilized for uplink traffic. This leaves additional frequency available for the guard band. In this example, a guard band at 88 is 2.75 MHz wide (i.e., 2.5 MHz+0.25 MHz) and a guard band at 89 is 0.16 MHz wide.

In the examples of FIGS. 4 and 5, the guard band between the allocated 5 MHz band and the aggregated 3 MHz band or 1.4 MHz bands is shared to reduce the overhead on the guard band.

The examples illustrated above provide carrier aggregation to improve spectrum efficiency. One downlink 10 MHz carrier is associated with multiple uplink carriers. The initial uplink 5 MHz band 70, 80 has an LTE release 8 frame structure and associated PUCCH control channels. Downlink control signaling indicates the resource allocation on the initial uplink 5 MHz carrier 70, 80, the growth carrier 72, 82 or both.

The aggregated or growth carriers 72, 82 in one example include PUCCH on each component carrier to allow the aggregated carrier to associate with the downlink 10 MHz carrier 68 as a backward compatible LTE release-8 carrier. In another example, there is no PUCCH in the aggregated component carrier. In such an example, all CQI/PMI/RI and ACK/NAK are allocated at the original 5 MHz uplink carrier 70, 80. Such an example allows the system to fully utilize the additional or aggregated carrier 72, 82 for traffic.

A hybrid automatic repeat request (HARQ) processor in one example accommodates the above-described carrier aggregation by having one HARQ processor per component carrier. This example is backward compatible to LTE release-8 for all carriers. Another example includes one HARQ processor for aggregate multiple carriers scheduled for at least one user. This example provides a downlink control channel design that includes one ACK/NAK feedback only. Another example includes dynamic HARQ processors such that one or more HARQ processors are assigned based on demand.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of allocating bandwidth to a call for at least one network, comprising the steps of:
allocating 10 MHz of the bandwidth for a downlink between a base station and at least one user;
allocating 5 MHz of the bandwidth for an uplink between the at least one user and the base station; and
aggregating a selected bandwidth to the allocated 5 MHz for the uplink, the selected bandwidth being at least one of
an additional 3 MHz band or
two additional 1.4 MHz bands.

2. The method of claim 1, wherein the allocated bandwidth is within the frequency range from 700 MHz to 800 MHz.

3. The method of claim 2, wherein the allocated bandwidth is within the frequency range from 740 MHZ to 790 MHz.

4. The method of claim 2, wherein the allocated 10 MHz is at a lower frequency than the allocated 5 MHz and the aggregated selected bandwidth and the allocated 5 MHz and the aggregated selected bandwidth are associated with the allocated 10 MHz bandwidth for the downlink.

5. The method of claim 1, wherein the allocated 5 MHz and the aggregated selected bandwidth are all within a frequency range that is 10 MHz wide.

6. The method of claim 1, comprising
providing a guard band on both sides of the allocated bandwidth for the uplink utilizing less than all of the allocated bandwidth for uplink traffic.

7. The method of claim 6, wherein the aggregated bandwidth is 3 MHz and the method comprises
utilizing 4.5 MHz of the allocated 5 MHz for the uplink traffic;
providing a 0.25 MHz guard band on one side of the allocated uplink bandwidth;
utilizing 2.7 MHz of the aggregated 3 MHz for the uplink traffic; and
providing a 2.15 MHz guard band on an opposite side of the allocated uplink bandwidth.

8. The method of claim 6, wherein the aggregated bandwidth is the two 1.4 MHz bands and the method comprises
utilizing 4.5 MHz of the allocated 5 MHz for the uplink traffic;
providing a 2.75 MHz guard band on one side of the allocated uplink bandwidth;
utilizing 1.08 MHz of each of the aggregated 1.4 MHz bands for the uplink traffic; and
providing a 0.16 MHz guard band on an opposite side of the allocated uplink bandwidth.

9. The method of claim 1, wherein the allocated bandwidths and the aggregated bandwidth are all in the 700 MHz frequency spectrum.

10. The method of claim 9, wherein the allocated 5 MHz and the aggregated bandwidth are between 777 MHz and 787 MHz.

11. The method of claim 10, wherein the allocated 5 MHz is centered at 782 MHz.

12. The method of claim 11, wherein the aggregated bandwidth is the two additional 1.4 MHz bands and the aggregated bandwidth is between 784 MHz and 787 MHz.

13. The method of claim 10, wherein the allocated 5 MHz is between 782 MHz and 787 MHz.

14. The method of claim 13, wherein the aggregated bandwidth is the additional 3 MHz band and the aggregated bandwidth is between 779 MHz and 782 MHz.

15. The method of claim 1, comprising
utilizing less than all of the allocated 5 MHz and less than all of the aggregated bandwidth for traffic on the uplink; and
providing a guard band shared between the allocated 5 MHz and the aggregated bandwidth using some of a remainder of at least the allocated 5 MHz that is not utilized for traffic on the uplink.

16. The method of claim 6, where the resources of the allocated 5 MHz and the aggregated selected bandwidth are managed as an unity and associated together with the allocated 10 MHz resource.
